(19) United States
(12) Patent Application Publication
(10) Pub. No.: US 2025/0178499 A1
(43) Pub. Date: Jun. 5, 2025

(54) VEHICLE SEAT COMPRISING A PADDING FORMED BY A RANDOM ENTANGLEMENT OF CONTINUOUS THERMOPLASTIC FIBERS

(71) Applicant: FAURECIA Sièges d'Automobile, NANTERRE (FR)

(72) Inventor: Mathieu CLUET, ETAMPES (FR)

(21) Appl. No.: 18/851,415

(22) PCT Filed: Mar. 24, 2023
(86) PCT No.: PCT/FR2023/050422

§ 371 Date: Sep. 26, 2024

(30) Foreign Application Priority Data
Mar. 31, 2022 (FR) 2202947

(51) Int. Cl. B60N 2/66

(52) U.S. Cl. CPC B60N 2/66

(57) ABSTRACT

The present disclosure relates to a seat (1) comprising:—a structure (2), typically metallic,—a padding (3),—an interface (4) between the structure (2) and the padding (3), and wherein the padding (3) comprises a 3D entanglement of randomly arranged continuous thermoplastic fibers (5) forming welded loops between the fibers.

The present disclosure relates to a vehicle seat comprising a structure, typically metallic, a padding and an interface interposed between the structure and the padding.

According to the present disclosure the padding comprises a random entanglement of continuous, thermoplastic, three-dimensional fibers, the fibers welded together by loops between the fibers.

### TECHNICAL FIELD

The present disclosure relates to the field of motor vehicle seats which comprise a typically metal structure, typically with a squab frame and a backrest frame. The structure is conventionally obtained by stamping techniques. The seats further comprise paddings, including a layer of squab padding and a layer of backrest padding that impart the softness of the squab and the backrest, and participate in comfort in the seat.

### PRIOR ART

The squab and backrest paddings are conventionally made of foam of urethane polymer, and shaped in molds. The polyurethane foam padding are satisfactory, but may in wet condition, retain moisture.

Furthermore, a polyurethane foam is conventionally produced by mixing, inter alia, polyols with isocyanates. The chemical reaction used emits CO₂ to form a foam, the emitted CO₂ contributing to global warming.

Furthermore, a polyurethane foam is hard to recycle.

Also, it appears desirable to limit the use of polyurethane in the padding of vehicle seat elements.

### SUMMARY

The present disclosure improves the situation.

A seat is proposed, comprising:
a. a typically metallic structure,
a padding,
an interface between the structure and the padding,
   and wherein the padding comprises a 3D entanglement of randomly arranged continuous thermoplastic fibers forming welded loops between the fibers, and wherein:
the fibers are hollow fibers and/or solid fibers, with a diameter of between 0.2 mm and 2 mm, preferentially between 0.3 mm and 1.5 mm,
the fibers comprise a thermoplastic polymer, the composition of the fibers comprising at least 95% by weight of PET,
   and wherein the 3D entanglement of the padding has a bulk density between 35 kg/m³ and 55 kg/m³.

In this way, the padding is made at least in part, and preferably for the most part, from a material other than polyurethane foam. This padding material is advantageously a recyclable plastic material and its production generates less CO₂ emissions than the production of a polyurethane foam, thus reducing the ecological impact of the seat comprising such padding. Besides the environmental advantages, the method using this material for the padding can make it possible to create a padding substantially lighter than a similar padding made of polyurethane foam. In addition, the padding material may be more breathable, allowing air and any moisture to pass through the padding better.

According to one embodiment, the padding is a squab padding in the form of a squab padding layer, extending lengthwise in a longitudinal direction of the squab from a rear edge to a front edge of the squab, and widthwise along a transverse direction of the squab from a first lateral edge to a second lateral edge, as well as thickness along an orthogonal direction, which is orthogonal to the longitudinal direction and to the transverse direction of the squab.

According to one embodiment, the padding is a backrest padding in the form of a backrest padding layer, extending lengthwise in a longitudinal direction of the backrest from a lower edge to an upper edge of the backrest, and in width along a transverse direction of the backrest from a first lateral edge to a second lateral edge, as well as thickness along an orthogonal direction, which is orthogonal to the longitudinal direction and to the transverse direction of the backrest.

According to one embodiment, the thickness of the backrest padding layer may be comprised between 15 mm and 50 mm and/or the thickness of the squab padding layer may be between 60 mm and 100 mm.

According to one embodiment, the backrest padding layer may comprise different areas having different bulk densities, distributed along the longitudinal direction of the backrest padding layer and/or the squab padding layer may comprise different areas having different bulk densities, along the longitudinal direction of the squab padding layer.

In one embodiment, the interface may comprise a material made entirely or partly of plastic. Said interface may be made of ABS and/or PC and/or P/E.

In particular, the interface can be a backrest interface comprising:
at least one deformable backrest shell, receiving the padding which is a backrest padding, said deformable shell being configured to take different shapes from an initial position of lumbar lordosis to a final position of lumbar kyphosis, in response to a variable load applied by the back of the occupant of the seat,
a system coupling said deformable shell to the structure comprising upper movement control links, and lower movement control links.

According to one embodiment, the squab padding layer and/or the backrest padding layer comprises, depending on thickness:
a lower, structural underlayer formed from an entanglement of hollow fibers, of thickness Epinf,
an upper, soft underlayer formed from an entanglement of solid fibers Epsup,
an intermediate, binding underlayer between the lower underlayer and the upper underlayer, comprising an entanglement of solid fibers and hollow fibers welded to one another, of thickness Epint.

According to one embodiment, the padding layer comprises, by weight:
95% to 99% of a first polymer of the polyester family such as PET,
1% to 5% of a second polymer of the family of polyesters, such as PET, such as PTT or PBT. The second polymer is distinct from the first polymer.

Preferably, the voids between the fibers of the 3D entanglement of fibers of the padding are left free.

According to one embodiment, the padding comprising said 3D entanglement of continuous thermoplastic fibers is supported by an inner face of said 3D entanglement of continuous thermoplastic fibers on said interface. A cap may optionally cover an outer face of said thermoplastic continuous fiber entanglement. The cap is attached to said interface, configured to hold the padding in place on said interface.

According to an embodiment, said padding comprising said 3D entanglement of thermoplastic continuous fibers simply rests on said interface, i.e. said padding is not glued (or welded) to said interface, so as to allow the separation of the padding and said interface after said cap is removed.

The present disclosure further relates to a method for manufacturing a seat according to the present disclosure wherein the padding comprising a 3D entanglement of randomly arranged, continuous, thermoplastic fibers forming loops welded together is obtained by a continuous method comprising:
/A/ Extrusion of a thermoplastic polymer in an extrusion die comprising extrusion nozzles distributed in a lengthwise direction and along a widthwise direction of the extrusion die, generating a curtain of continuous molten fibers, falling by gravity,
/B/ Receiving the curtain of continuous molten fibers falling under gravity between two counter-rotating guide members, with a generation of a 3D entanglement of fibers according to a random distribution, with melting of the loops between the continuous fibers, according to a layer whose thickness is determined by the center distance between the two counter-rotating members,
/C/ solidifying the 3D entanglement of fibers by means of immersion in a cooling liquid.

According to one embodiment of the method, the extrusion die comprises, along the lengthwise direction of the extrusion die, multiple separate areas comprising different surface densities of nozzles, comprising at least one first area with a low surface density of nozzles, and at least one second area with a high surface density of nozzles in such a way as to obtain at least a first area having a low bulk density and at least a second area having a high bulk density, along the direction of the 3D entanglement of fibers extending along the longitudinal direction of the extrusion die.

According to one embodiment, which may optionally be combined with the preceding one, the extrusion die comprises, along the widthwise dimension of the extrusion die, a first section provided with first extrusion nozzles for generating hollow fibers, and a second section provided with second extrusion nozzles for the generating solid fibers.

According to one embodiment, the temperature of the extrusion implemented in /A/ in the extrusion die is between 180° C. and 240° C.

### BRIEF DESCRIPTION OF THE DRAWINGS

Other features, details and advantages will become apparent on reading the following detailed description and the analysis of the appended drawings, in which:

FIG. 1 is a view of a motor vehicle seat, according to one embodiment, showing the metal structure of the seat supporting a plastic backrest interface intended to receive a squab padding layer and a plastic seat interface, intended to receive a layer of squab padding, the backrest and squab padding being not shown.

FIG. 2 is a cross sectional view of the seat of FIG. 1, on which a layer has been added of backrest padding and squab padding, according to the present disclosure. comprising a random entanglement in three dimensions 3D of continuous thermoplastic fibers comprising loops of fibers heat-welded to one another.

FIG. 3 is a schematic view of the method for manufacturing 3D entanglement comprising extruding a thermoplastic polymer in an extrusion die generating a curtain of continuous molten fibers, falling by gravity, receiving the curtain of continuous molten fibers between two counter-rotating guide members, generating a 3D entanglement of fibers and solidifying the 3D entanglement of fibers by immersion in a cooling liquid, and then obtaining padding through cuts transverse to the run direction.

FIG. 4 shows different extrusion dies which can be implemented according to the method of the present disclosure, namely an extrusion die comprising extrusion nozzles for the extrusion of solid fibers for obtaining a padding from the solid fibers according to a first possibility, an extrusion die comprising extrusion nozzles for the extrusion of hollow fibers for obtaining a padding from the hollow fibers according to a second possibility, and a mixed extrusion die, comprising extrusion nozzles for the extrusion of hollow fibers and extrusion nozzles for the extrusion of solid fibers according to a third possibility, making it possible to obtain a padding comprising, depending on thickness, a lower, structural underlayer formed from an entanglement of hollow fibers, an upper, soft underlayer formed from an entanglement of solid fibers, and an intermediate, binding underlayer between the lower underlayer and the upper underlayer.

FIG. 5 shows, on the one hand, above, an extrusion die with a surface density of the number of extrusion nozzles configured to obtain a padding of homogeneous bulk density in the longitudinal direction of the extrusion die, and below, an extrusion die comprising multiple separate areas respectively comprising different surface densities in terms of the numbers of nozzles, comprising areas with a low surface density in terms of the number of nozzles and areas with a high surface density in terms of the number of nozzles, so as to obtain two areas with a low bulk density and three areas with a high bulk density in the direction of the 3D entanglement of fibers extending in the longitudinal direction of the extrusion die, the areas with a low density and the areas with a high density being distributed alternately over the length of the die.

FIG. 6 shows, in cross-sectional view, an assembly between said interface, the padding, and a cap covering the padding, fastened to said interface, the shell forming the interface having raised edges ensuring the shaping of lateral holding portions, projecting on either side of a central portion of the interface.

FIG. 7 is a detail view of FIG. 7, showing the mechanical coupling of the cap to said interface shell, by means of a hooking rib and hooking groove pair.

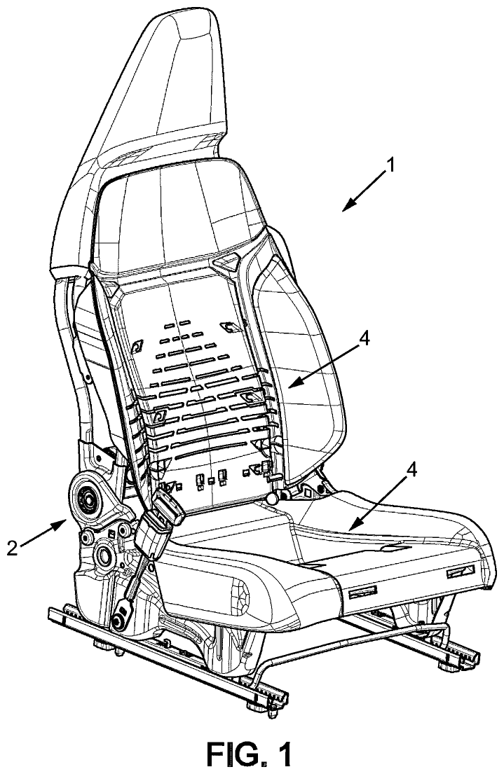

### DESCRIPTION OF THE EMBODIMENTS

The following drawings and description contain, for the most part, elements of certainty. They may therefore not only serve to enhance understanding of this disclosure, but also contribute to its definition, where appropriate.

Thus, the present disclosure relates to a seat 1 comprising:
a structure 2, typically metallic,
a padding 3.
an interface 4 between the structure 2 and the padding 3,

The padding 3 can be covered by a cap 9. The cap 9 can typically be attached at its edges to the interface 4. Fastening the cap to said interface 4 can ensure that the padding 3 is held in place on said interface 4, preferably by simply resting on it.

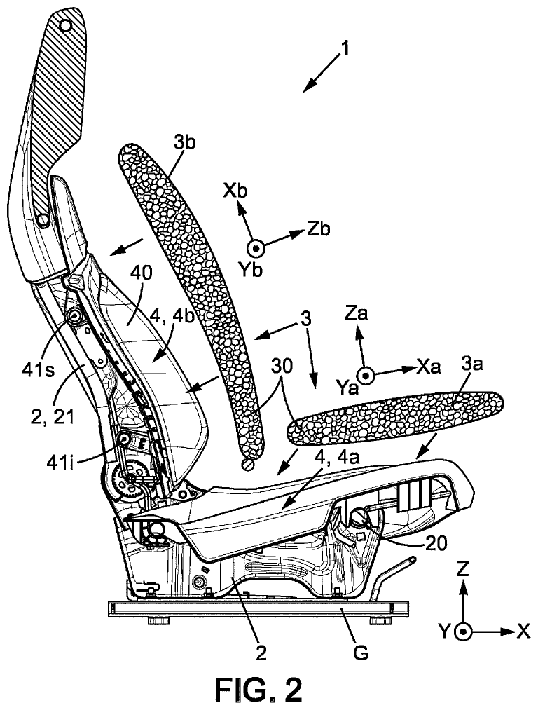

In FIG. 2, a reference frame XYZ is shown, the direction X oriented along the sliding direction of the slide G between the seat structure 2 and a floor of the vehicle, the direction Y, oriented along a transverse direction of the seat, and the direction Z along the vertical.

The structure 2 typically made of metal comprises a seat frame 20 and a backrest frame 21, typically articulated around a transverse axis of rotation, typically by means of articulations of the continuous type.

The squab frame 20 typically comprises:
two lateral flanges, extending from a rear edge of the backrest and to a front edge, along the direction X, or slightly inclined relative to the longitudinal direction X (typically by plus or minus 30 degrees) around a transverse axis and,
a front part connecting two front ends of the flanges, and extending in the transverse direction. The front piece and the flanges are typically sheets shaped, for example, by stamping techniques.

The backrest frame typically comprises lateral uprights, extending height wise, as well as an upper cross-member connecting two upper ends of the uprights. The uprights and the upper cross-member are typically shaped sheets, for example by stamping techniques.

The padding 3 typically comprises a squab padding layer 3a which confers the comfort of the seat and which is received on a squab interface 4a inserted between the squab frame 20 and the squab padding layer 3a and/or the padding 3 typically comprises a backrest padding layer 3b which confers the comfort of the backrest and which is received on a backrest interface 4b which is inserted between the backrest frame 21 and the backrest padding layer 3b.

The padding 3, in particular the squab padding 3a and/or the backrest padding layer 3b comprises a three-dimensional (“3D”) entanglement 30 of continuous, thermoplastic fibers 5 arranged randomly, forming loops heat-sealed together between the fibers 5.

The fibers may be hollow fibers 5a and/or solid fibers 5b. The fibers may have a diameter comprised between 0.2 mm and 2 mm, preferentially between 0.3 mm and 1.5 mm. “Continuous” in “continuous fibers” means that the fibers have a length much greater than the diameter of the fibers, and because of the method which is described below, typically at least a ratio of 100, or even 500, or even 1000.

The fibers 5 comprise a thermoplastic polymer, the composition of the fibers preferably comprising at least 95% by weight of PET. For example, the composition of the fibers, or even the padding comprises:
95% to 99% by weight of a first polymer of the polyester family such as PET (polyethylene terephthalate),
1% to 5% by weight of a second polymer of the family of polyesters, such as PTT (polyethylene terephthalate) or PBT (polybutylene terephthalate). The sum of the PET and of the PTT (or PBT) can be 100% by weight of the fibers, or even of the padding. The 3D entanglement of the padding 5 may have a bulk density of between 35 kg/m³ and 55 kg/m³.

Preferably, the voids between the fibers 5 of the 3D entanglement of fibers 5 of the padding 3 are left free. A very breathable padding is obtained, because of the numerous interspaces between the fibers that promote air circulation.

The base padding layer 3a extends length along a longitudinal direction Xa of the squab from a rear edge to a front edge of the squab, and width along a transverse direction a of the squab from a first lateral edge to a second lateral edge, as well as thickness along an orthogonal direction Za, which is orthogonal to the longitudinal direction and the transverse direction of the squab. The thickness of the layer of squab padding may be between 60 mm and 100 mm.

The backrest padding layer 3b extends length along a longitudinal direction Xb of the backrest from a rear edge to a front edge of the backrest, and width along a transverse direction Yb of the backrest from a first lateral edge to a second lateral edge, as well as thickness along an orthogonal direction Zb, which is orthogonal to the longitudinal direction and to the transverse direction of the backrest. The thickness of the layer of backrest padding may be between 15 mm and 50 mm.

The interface 4, in particular the squab interface 4a or the backrest interface 4b may comprise a material that is entirely or partially made of plastic. For example, said interface 4 is made of ABS (acrylonitrile butadiene styrene) and/or PC (Polycarbonate) and/or P/E (polypropylene/polyethylene copolymer).

In general, the interface 4, in particular the squab interface 4a or the backrest interface 4b may comprise a shell. The shell may be a molded part or a thermoformed part. The cap 9 can be attached to the shell by means of the cap edges 9 on the shell edges. A squab cap covers the squab padding 3a and is attached to the squab interface 4a, in particular to the edges of the shell. A backrest cap covers the backrest padding 3b and is attached to the backrest interface 4b, in particular to the edges of the shell.

To this end, and according to a fastening variant, the shell of the interface 4 can comprise hooking grooves 10 extending along the edges of the shell, inside which integral complementary hooking ribs 11 can be locked, along the edges of the cap 9.

According to other variants, the fastening system between the shell and the cap can be:
a zipper, or
a hook-and-loop fastening system.

Said 3D entanglement of continuous thermoplastic fibers 5 is supported by an inner face of said 3D entanglement of continuous thermoplastic fibers 5 on said interface 4, in particular on the shell of the squab interface 4a or the backrest interface 4b, the cap covering an outer face of said entanglement of continuous thermoplastic fibers 5.

In one embodiment, the padding 3, in particular the squab padding 3a or backrest padding 3b, simply rests on said interface 4, i.e. is not bonded or welded to it.

Recycling is advantageously simplified, as said padding 3, and in particular said 3D entanglement of continuous thermoplastic fibers 5, can be easily separated from said interface 4, for example after removing the cap 9.

In particular, said backrest interface 4b may comprise:
at least one deformable backrest shell 40, receiving the padding which is a backrest padding 3b, said deformable shell 40 being configured to take different shapes in particular from an initial position of lumbar lordosis and in particular to a final position of lumbar kyphosis, in response to a variable load applied by the back of the occupant of the seat,
a system coupling said deformable shell 40 to the structure comprising upper movement control links 41s, and lower movement control links 41i.

The upper movement control links 41s and/or the lower movement control links 41i are typically articulated links which can comprise connecting rods.

The backrest padding 3b resting on the deformable shell 40 and held to the shell by the cap 9, as well as said cap 9 covering the backrest padding, accompany the deformation of the deformable shell 40, in response to a variable load applied by the seat occupant's back.

In general, said interface 4, in particular the squab interface 4a or the backrest interface 4b may comprise, in a transverse direction Ya, Yb raised edges 41 comprising a vertical component Za, Zb, on either side of a central portion 42 of said interface 4, in particular of the shell, in particular the deformable shell 40.

The raised edges of said interface 4 ensure the shaping of the padding 3, in particular the squab padding 3a or the backrest padding 3b, which is typically a 3D entanglement layer of thermoplastic fibers 5 of constant thickness to form a squab or backrest comprises, along the transverse direction Ya, Yb, a central portion and lateral holding portions, protruding from the central portion.

In the case of the squab, the central portion receives the thighs and/or the buttocks of the occupant of the seat, and said lateral holding portions, arranged on either side of the central portion along the direction Ya, ensure the lateral holding, typically in turns.

In the case of the backrest, the central portion receives the back of the occupant of the seat and said lateral holding portions, arranged on either side along the transverse direction Yb, ensure the lateral holding, typically in turns.

The present disclosure also relates to a method for manufacturing a seat according to the present disclosure. According to the present disclosure, the padding 3 is obtained comprising a 3D entanglement of continuous, randomly arranged thermoplastic fibers 5 forming loops welded together by a continuous manufacturing method.

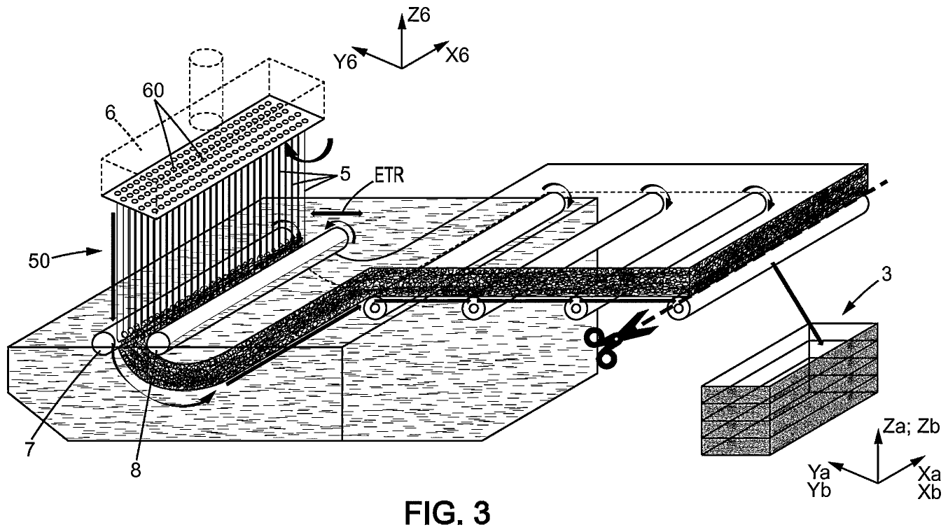

This continuous method comprises, as schematically shown in FIG. 3:
/A/ Extrusion of a thermoplastic polymer in an extrusion die 6 comprising extrusion nozzles 60 distributed in a lengthwise direction X6 and along a widthwise direction Y6 of the extrusion die, generating a curtain of continuous molten fibers 50, falling by gravity,
/B/ Receiving the curtain 50 of continuous molten fibers falling under gravity between two counter-rotating guide members 7, 8, with a generation of a 3D entanglement of fibers 5 according to a random distribution, with melting of the loops between the continuous fibers, in particular according to a layer whose thickness is determined by the center distance ETR between the two counter-rotating members 7, 8,
/C/ Solidification of the 3D entanglement of fibers by immersion in a cooling liquid, such as water.

The extrusion nozzles 60 are preferably distributed regularly along the lengthwise direction X6 of the extrusion die, as well as in width along the widthwise direction Y6.

The thickness of the padding layer formed by the entanglement can be adjusted, by adjusting the center distance between the two guide members 7,8.

In /B/, the two guide members 7, 8 are driven in rotation at a speed, typically lower than the speed of fall of the fibers, ensuring an accumulation of the fibers at the origin of the formation of loops that are welded together between fibers, generating the random entanglement in three dimensions. The solidification in /C/ is obtained just after step /B/, the two guide members being able to be immersed at mid-height, for this purpose.

The extrusion temperature implemented in /A/ in the extrusion die is typically between 180° and 240° C. The extrusion die is fed with granules of polymer.

The 3D entanglement layer of fibers, continuously running, is then guided, outside the cooling liquid reservoir to be dried, typically by shaking/vibrations. The running layer is then cut, by transverse cuts, making it possible to obtain different paddings 3, and as can be seen in FIG. 3. These paddings 3 extend lengthwise, for example lengthwise along the longitudinal direction Xa of the squab padding layer (or in length along the longitudinal direction Xb of the backrest padding layer), typically along the direction transverse to the passage of the layer.

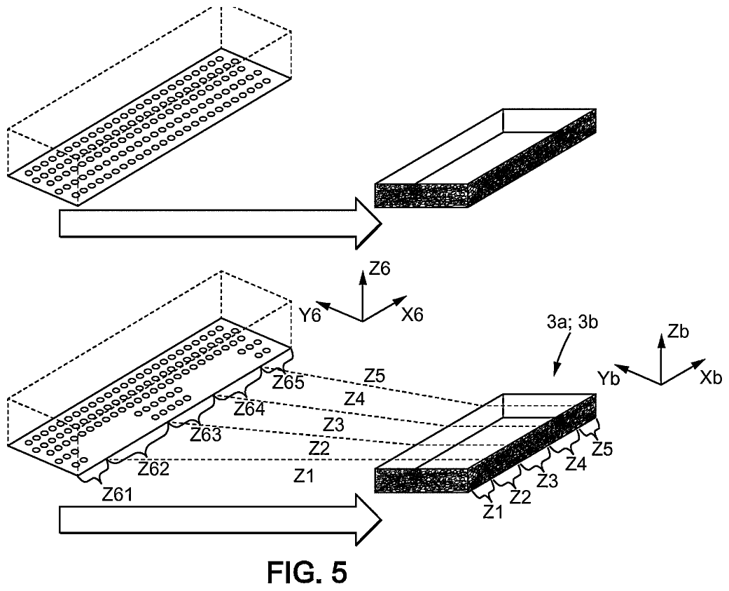

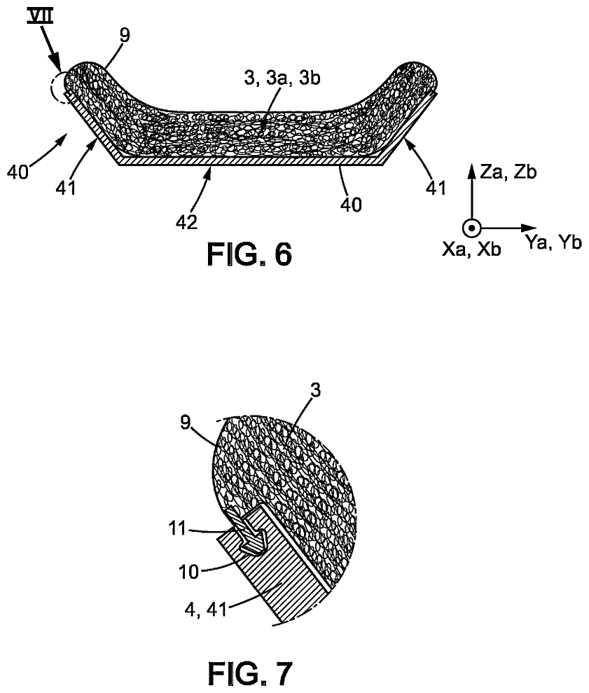

According to one embodiment, the bulk density can be homogeneous along the length and width of the layer, and as shown in FIG. 5, at the top. The density of the number of extrusion nozzles is thus homogeneous along the lengthwise direction of the extrusion die.

According to another embodiment visible at the bottom of FIG. 5, the extrusion die 6 can comprise, along the longitudinal direction X6 of the extrusion die, multiple distinct areas Z61, Z62, Z63, Z64, Z65 comprising distinct surface densities in terms of number of nozzles, comprising at least a first area Z62, Z64 with a low surface density in terms of number of nozzles, and at least a second area Z61, Z63, Z65 with a high surface density in terms of number of nozzles.

Such a method makes it possible to obtain at least one first area Z2, Z4 with a low bulk density and at least one second area Z1, Z3, Z5 with a high bulk density, in the direction of the 3D fiber entanglement extending in the longitudinal direction X6 of the extrusion die.

For example, as shown in FIG. 5, two shutters are inserted to close off some of the extrusion nozzles, dividing the extrusion die 6 into five consecutive areas Z61 to Z65, along the longitudinal direction X6 of the die, the five areas alternating between areas with a high density of extrusion nozzles (respectively areas marked Z61, Z63, Z65) and areas with a low density of nozzles (respectively areas marked Z62 and Z64).

Thus, and advantageously:
the resulting squab padding layer 3a may thus comprise different areas Z1, Z2, Z3, Z4, Z5 with different bulk densities, along the longitudinal direction Xa of the squab padding layer 3a and/or,
the resulting backrest padding layer 3b may thus comprise different areas Z1, Z2, Z3, Z4, Z5 with different bulk densities, distributed along the longitudinal direction Xb of the backrest padding layer 3b.

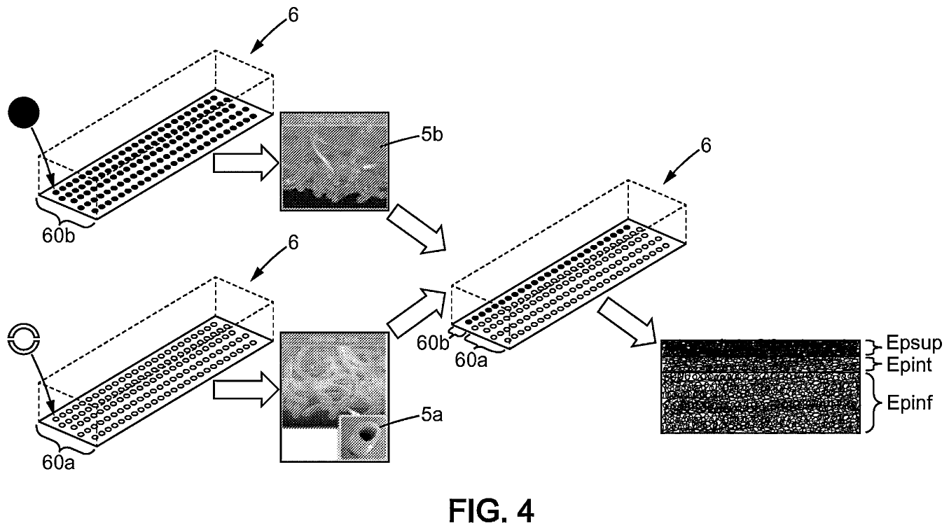

In one embodiment, the extrusion die may comprise extrusion nozzles configured for the extrusion of solid fibers only, and as shown at top left in FIG. 4, enabling solid-fiber padding to be obtained.

In another embodiment, the extrusion die may comprise extrusion nozzles configured for the extrusion of hollow fibers only, and as shown at bottom left in FIG. 4, enabling hollow-fiber padding to be obtained.

According to another shown embodiment, the extrusion die 6 can comprise not only extrusion nozzles for extruding solid fibers, but also extrusion nozzles for extruding hollow fibers.

As shown in the middle view of FIG. 4, the extrusion die 6 can comprise, depending on the width dimension Y6 of the extrusion die, a first section 60a with first extrusion nozzles for generating hollow fibers 5a that extend lengthwise along the length of the die 6, and a second section 60b with second extrusion nozzles for generating solid fibers 5b that extend lengthwise along the length of the die 6.

As shown in the right-hand view in FIG. 4, the squab padding layer 3a and/or the backrest padding layer 3b may comprise, depending on thickness:
a lower, structural underlayer formed from an entanglement of hollow fibers 5a, of thickness Epinf,
an upper, soft underlayer formed from an entanglement of solid fibers Epsup,
an intermediate, binding underlayer between the lower underlayer and the upper underlayer, comprising an entanglement of solid fibers and hollow fibers welded to one another, of thickness Epint.

The bulk density of the lower underlayer and the bulk density of the upper underlayer can be identical or within 5% depending on the layer thickness, at least locally along the longitudinal direction and transverse dimension of the layer.

Generally speaking, as shown in FIG. 4, the thickness Epsup of the upper underlayer, formed by the solid fibers 5b, is less than the thickness Epinf of the structural underlayer, formed by the hollow fibers 5a.

List of reference signs
1: Seat,
2: Structure,
3: Padding,
3a: Squab padding layer,
Xa, Ya, Za: Lengthwise, widthwise and thickness directions of the squab padding layer,
3b: Backrest padding layer,
30. 3D fiber entanglement,
Xb, Yb, Zb: Lengthwise, widthwise and thickness directions of the backrest padding layer,
4: Interface,
41s, 41i. Upper and lower movement control links,
5: Fibers,
5a. Hollow fibers,
5b. Solid fibers,
Z1, Z2, Z3, Z4, Z5: Areas of the padding layer with different bulk densities.
6 Extrusion die,
60 Extrusion nozzles,
60a. Extrusion nozzles for hollow fiber extrusion,
60b. Extrusion nozzles for solid fiber extrusion,
7, 8. Counter-rotating guide members,
9 Cap.

1-15. (canceled).

16. A seat comprising:
a structure,
a padding,
an interface between the structure and the padding,
wherein the padding comprises a 3D entanglement of randomly arranged continuous thermoplastic fibers forming welded loops between the fibers, and wherein:
the fibers are hollow fibers and/or solid fibers, with a diameter of between 0.2 mm and 2 mm,
the fibers comprise a thermoplastic polymer, the composition of the fibers comprising at least 95% by weight of PET,
and wherein the 3D entanglement of the padding has a bulk density between 35 kg/m³ and 55 kg/m³.

17. The seat according to claim 16, wherein:
the padding is a squab padding in the form of a squab padding layer, extending lengthwise in a longitudinal direction of the squab from a rear edge to a front edge of the squab, and in width along a transverse direction of the squab from a first lateral edge to a second lateral edge, as well as thickness along an orthogonal direction, which is orthogonal to the longitudinal direction and to the transverse direction of the squab, and wherein the thickness of the squab padding layer may be between 60 mm and 100 mm, and/or
the padding is a backrest padding in the form of a backrest padding layer, extending lengthwise in a longitudinal direction of the backrest from a rear edge to a front edge of the backrest, and in width along a transverse direction) of the backrest from a first lateral edge to a second lateral edge, as well as thickness along an orthogonal direction, which is orthogonal to the longitudinal direction and to the transverse direction of the backrest, and wherein the thickness of the backrest padding layer may be between 15 mm and 50 mm.

18. The seat according to claim 16, wherein the interface comprising a wholly or partially plastic material.

19. The seat according to claim 18, wherein said interface is made of ABS and/or PC and/or P/E.

20. The seat according to claim 16, wherein the interface is a backrest interface comprising:
at least one deformable backrest shell, receiving the padding which is a backrest padding, said deformable shell being configured to take different shapes from an initial position of lumbar lordosis to a final position of lumbar kyphosis, in response to a variable load applied by the back of the occupant of the seat,
a system coupling said deformable shell to the structure comprising upper movement control links, and lower movement control links.

21. The seat according to claim 16, wherein the padding is a squab padding in the form of a squab padding layer extending lengthwise in a longitudinal direction of the squab from a rear edge to a front edge of the squab, and in width along a transverse direction of the squab from a first lateral edge to a second lateral edge, as well as thickness along an orthogonal direction, which is orthogonal to the longitudinal direction and to the transverse direction of the squab, and/or
the padding is a backrest padding in the form of a backrest padding layer, extending lengthwise in a longitudinal direction of the backrest from a rear edge to a front edge of the backrest, and in width along a transverse direction of the backrest from a first lateral edge to a second lateral edge, as well as thickness along an orthogonal direction, which is orthogonal to the longitudinal direction and to the transverse direction of the backrest, and wherein the backrest padding layer comprises different areas having different bulk densities, distributed along the longitudinal direction of the backrest padding layer, and/or
and wherein the squab padding layer comprises different areas with different bulk densities, along the longitudinal direction of the squab padding layer.

22. The seat according to claim 16, wherein the padding is a squab padding in the form of a squab padding layer extending lengthwise in a longitudinal direction of the squab from a rear edge to a front edge of the squab, and widthwise along a transverse direction of the squab from a first lateral edge to a second lateral edge, as well as thickness along an orthogonal direction, which is orthogonal to the longitudinal direction and to the transverse direction of the squab, and/or
the padding is a backrest padding in the form of a backrest padding layer, extending lengthwise in a longitudinal direction of the backrest from a lower edge to an upper edge of the backrest, and in width along a transverse direction of the backrest from a first lateral edge to a second lateral edge, as well as thickness along an orthogonal direction, which is orthogonal to the longitudinal direction and to the transverse direction of the backrest,
and wherein the squab padding layer and/or the backrest padding layer comprises, depending on thickness:
a lower, structural underlayer formed from an entanglement of hollow fibers, of thickness,
an upper, soft underlayer formed from an entanglement of solid fibers,
an intermediate, binding underlayer between the lower underlayer and the upper underlayer, comprising an entanglement of solid fibers and hollow fibers welded to one another, of thickness.

23. The seat according to claim 22, wherein the bulk density of the lower underlayer and the bulk density of the upper underlayer are identical or within 5% of one another over the thickness of the layer, at least locally in the longitudinal direction and transverse dimension of the layer.

24. The seat according to claim 16, wherein the padding layer comprises, by weight:
95% to 99% PET,
1% to 5% of a second polymer distinct from PET, such as PTT or PBT.

25. The seat according to claim 16, wherein the voids between the fibers of the 3D entanglement of fibers of the padding are left free.

26. The seat according to claim 16, wherein the padding comprising the 3D entanglement of continuous thermoplastic fibers rests with an inner face of said 3D entanglement of continuous thermoplastic fibers on said interface, a cap covering an outer face of said entanglement of continuous thermoplastic fibers, and wherein said cap is attached to said interface, configured to hold the padding in place on said interface.

27. The seat according to claim 26, wherein the padding comprising said 3D entanglement of continuous thermoplastic fibers simply rests on said interface, said padding not glued or welded to said interface, so as to allow separation of the padding and said interface after said cap is removed.

28. A method for manufacturing the seat according to claim 16, wherein the padding is obtained comprising a 3D entanglement of randomly arranged, continuous thermoplastic fibers forming loops welded together by a continuous method comprising:
extrusion of a thermoplastic polymer in an extrusion die comprising extrusion nozzles distributed in a lengthwise direction and along a widthwise direction of the extrusion die, generating a curtain of continuous molten fibers, falling by gravity,
receiving the curtain of continuous molten fibers falling under gravity between two counter-rotating guide members, with a generation of a 3D entanglement of fibers according to a random distribution, with melting of the loops between the continuous fibers, according to a layer whose thickness is determined by the center distance between the two counter-rotating members, and
solidifying the 3D entanglement of fibers by means of immersion in a cooling liquid.

29. The method according to claim 28, wherein the extrusion die comprises, along the lengthwise direction of the extrusion die, multiple separate areas comprising different surface densities of nozzles, comprising at least one first area with a low surface density of nozzles, and at least one second area with a high surface density of nozzles in such a way as to obtain at least a first area having a low bulk density and at least a second area having a high bulk density, along the direction of the 3D entanglement of fibers extending along the longitudinal direction of the extrusion die.

30. The method according to 28, wherein the extrusion die comprises, along the widthwise dimension of the extrusion die, a first section provided with first extrusion nozzles for generating hollow fibers, and a second section provided with second extrusion nozzles for the generating solid fibers.
